(19) United States
(12) Patent Application Publication
(10) Pub. No.: US 2010/0080459 A1
(43) Pub. Date: Apr. 1, 2010

(54) CONTENT ADAPTIVE HISTOGRAM ENHANCEMENT

(75) Inventors: Min Dai, Encinitas, CA (US); Chia-Yuan Teng, San Diego, CA (US); King-Chuang Lai, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/238,775

(22) Filed: Sep. 26, 2008

(51) Int. Cl. G06T 7/00

(52) U.S. Cl. 382/170

(57) ABSTRACT

This disclosure describes techniques for performing content adaptive histogram enhancement. In accordance with the content adaptive histogram enhancement techniques of this disclosure, a frame of digital image data, e.g., digital video data or digital still image data, is classified into one of a plurality of content classes based on histogram of pixel intensity values of the frame. The content classes may represent various levels of brightness, contrast, or the like. To classify the frame into the corresponding content class, a shape of the histogram may be analyzed using various histogram statistics. Based on the content class of the frame, the pixel intensity values of the frame are mapped to new pixel intensity values.

### TECHNICAL FIELD

This disclosure relates to techniques for enhancing frames of digital video data and/or digital still image data.

### BACKGROUND

Digital image data is digital data that represents a visual scene. In the case of a digital camera, for example, the digital image data may be digital still image frame. In the case of a digital video camera, for example, the digital image data may be a digital video sequence that includes a sequence of video frames. The sequence of video frames may present one or more different visual scenes that are edited together to form a video clip or other production. The frames of the video sequence are presented to a viewer in rapid succession to create the impression of movement within the scenes.

Each of the video frames represents the scene as an array of pixels. Each pixel stores an intensity and/or a color for a specific point in the visual scene. In the Y-Cb-Cr color space, for example, each pixel value may be a combination of a luminance (Y) value that represents the intensity (i.e., intensity) of the specific point in the visual scene and two chrominance values Cb and Cr that represent a blue-difference and red-difference chroma components, respectively, of the specific point in the visual scene.

A histogram could be considered as an un-normalized probability mass function. In particular, the magnitude of each pixel intensity value in the histogram represents the frequency of occurrence of the corresponding pixel intensity value. Video frames or digital images may have different shape of pixel value distribution. For instance, most of the pixels of the histogram may have intensity values that cluster in a small sub-range of the possible range of intensity values. The cluster of pixel intensity values in the sub-range of possible pixel values may result in a peak in the histogram in the proximity of the sub-range. In some cases, the cluster of pixel values in the sub-range of possible pixel values may result in an image with many features that cannot be readily discerned by a human viewer.

Histogram enhancement attempts to redistribute the pixel intensity values over a wider range of the possible pixel intensity values. For example, histogram equalization, which is one form of histogram enhancement, may attempt to redistribute the pixel intensity values so that a histogram of an output video frame better approximates a uniform distribution over the entire range of possible pixel intensity values, which often over enhance the contrast in the image. Although generally developed for still image processing, histogram enhancement may be performed on video frames to make some features of the video frame more discernable to the human viewer. A direct application of image histogram enhancement to video applications may, however, result in visual artifacts, flickering or ringing, which causes harsh and noisy video output.

### SUMMARY

This disclosure describes techniques for performing content adaptive histogram enhancement. In accordance with the content adaptive histogram enhancement techniques of this disclosure, a frame of digital image data is classified into one of a plurality of content classes based on a histogram of the frame. The content classes may represent various levels of brightness, contrast, or the like. To classify the frame into the corresponding content class, a shape of the histogram may be analyzed using histogram statistics generated for the frame. For example, the histogram statistics may be analyzed to identify the existence and location of one or more peaks within the histogram, which may be indicative of the type of content within the frame. As another example, an average brightness of the pixel values of the frame may be analyzed to determine the type of content within the frame.

After classifying the frame into one of the content classes, the pixel intensity values of the frame are adjusted based on the content class of the frame to enhance a subjective visual quality of the frame. In one aspect, the pixel intensity values of the frame may be adjusted using a pixel mapping look-up table (LUT) corresponding to the content class to which the frame was classified. The LUT may map each of the pixel values to new pixel values, and may be generated in accordance with a mapping function associated with the content class. The LUT corresponding to the content class associated with the frame may be pre-computed or computed on the fly.

In one aspect, a method for processing digital image data that includes analyzing a distribution of pixel intensity values of a frame of the digital image data to classify the frame into one of a plurality of content classes and adjusting the pixel intensity values of the frame based on the classification of the frame.

In another aspect, a device for processing digital image data includes a frame classification unit that analyzes a distribution of pixel intensity values of a frame of the digital image data to classify the frame into one of a plurality of content classes. The device also includes pixel mapping unit to adjust the pixel intensity values of the frame based on the classification of the frame.

In another aspect, a computer-readable medium for processing digital image data comprises instructions that when executed cause at least one processor to analyze a distribution of pixel intensity values of a frame of the digital image data to classify the frame into one of a plurality of content classes and adjust the pixel intensity values of the frame based on the classification of the frame.

In another aspect, a device for processing digital image data comprises means for analyzing a distribution of pixel intensity values of a frame of the digital image data to classify the frame into one of a plurality of content classes and means for adjusting the pixel intensity values of the frame based on the classification of the frame.

The techniques described in this disclosure may be implemented in hardware, software, firmware, or any combination thereof. If implemented in software, the software may be executed in a processor, which may refer to one or more processors, such as a microprocessor, application specific integrated circuit (ASIC), field programmable gate array (FPGA), or digital signal processor (DSP), or other equivalent integrated or discrete logic circuitry. Software comprising instructions to execute the techniques may be initially stored in a computer-readable medium and loaded and executed by a processor.

Accordingly, this disclosure also contemplates computer-readable media comprising instructions to cause a processor to perform any of a variety of techniques as described in this disclosure. In some cases, the computer-readable medium may form part of a computer program product, which may be sold to manufacturers and/or used in a device. The computer program product may include the computer-readable medium, and in some cases, may also include packaging materials.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating a video encoding and decoding system that performs image enhancement techniques as described in this disclosure.

FIG. 2 is a block diagram illustrating a histogram enhancement unit in further detail.

FIG. 3 is a flow diagram illustrating an example operation of a histogram enhancement unit performing content adaptive histogram enhancement.

FIG. 4 is a flow diagram illustrating an example operation of a frame classification unit classifying a frame into one of a plurality of content classes.

FIG. 5 is a flow diagram illustrating an example operation of a frame classification unit determining the content class to use in performing histogram enhancement for a frame.

FIG. 6 is a flow diagram illustrating an example operation of a pixel mapping unit adjusting luma and chroma pixel values of a frame in accordance with a mapping function.

FIG. 7 is a graph showing an example mapping function for contrast enhancement.

FIG. 8 is a graph showing mapping functions for various classes versus a hue saturation intensity control (HSIC) function.

FIG. 9 is a block diagram of another example of a video encoding and decoding system that performs image enhancement techniques as described in this disclosure.

FIGS. 10A-10G are graphs illustrating example histograms of frames corresponding to different content classes.

### DETAILED DESCRIPTION

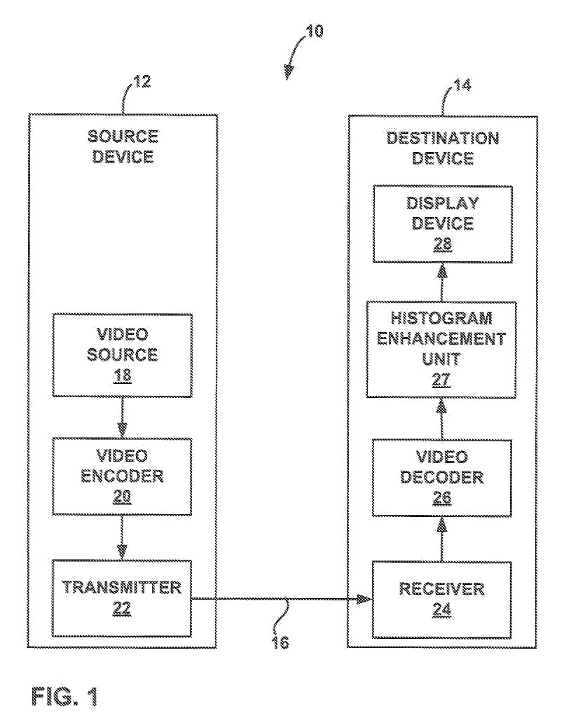

FIG. 1 is a block diagram illustrating a video encoding and decoding system 10 that performs image enhancement techniques as described in this disclosure. As shown in FIG. 1, system 10 includes a source device 12 that transmits encoded digital image data to a destination device 14 via a communication channel 16. Source device 12 generates coded digital image data for transmission to destination device 14. In the example illustrated in FIG. 1, source device 12 may include a video source 18, video encoder 20, and transmitter 22.

Video source 18 of source device 12 may include a video capture device, such as a video camera, a video archive containing previously captured video, or a video feed from a video content provider. As a further alternative, video source 18 may generate computer graphics-based data as the source video, or a combination of live video and computer-generated video. In some cases, source device 12 may be a so-called camera phone or video phone, in which case video source 18 may be a video camera. In each case, the captured, pre-captured, or computer-generated video, or a combination thereof, may be encoded by video encoder 20 for transmission from source device 12 to destination device 14 via transmitter 22 and communication channel 16.

Video encoder 20 receives video data from video source 18 and encodes the video data. The video data received from video source 18 may be a series of video frames. Each of the video frames represents a visual scene as an array of pixel values. Each pixel value of the array represents an intensity and/or a color for a specific point in the visual scene. In the Y-Cb-Cr color space, for example, each pixel value may be a combination of a luminance (Y) value that represents the brightness (i.e., intensity) of the specific point in the visual scene and two chrominance values Cb and Cr that represent the blue and red dominated color components, respectively, of the specific point in the visual scene.

Although described in this disclosure in terms of Y-Cb-Cr color space, the techniques of this disclosure may be extended to other color spaces or domains, such as the R-G-B color space. In the R-G-B color space, the pixel value may be represented by a red (R) channel value that represents the intensity of the red component of the specific point in the visual scene, a green (G) channel value that represents the intensity of the green component of the specific point in the visual scene and a blue (B) channel value that represents the intensity of the blue component of the specific point in the visual scene. As such, the term “pixel value” may refer to information that defines a brightness and/or color of the pixel at a pixel location.

Video encoder 20 may divide the series of frames into coded units and process the coded units to encode the series of video frames. The coded units may, for example, be entire frames or portions of the frames, such as slices of the frames. Video encoder 20 may further divide each coded unit into blocks of pixels (referred to herein as video blocks or blocks) and operate on the video blocks within individual coded units in order to encode the video data. As such, the video data may include multiple frames, a frame may include multiple slices, and a slice may include multiple video blocks.

The video blocks may have fixed or varying sizes, and may differ in size according to a specified coding standard. As an example, International Telecommunication Union Standardization Sector (ITU-T) H.264/Motion Pictures Expert Group (MPEG)-4, Part 10 Advanced Video Coding (AVC) (hereinafter “H.264/MPEG-4 Part 10 AVC” standard), supports intra prediction in various block sizes, such as 16×16, 8×8, or 4×4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In H.264/MPEG-4 Part 10 AVC, each video block, often referred to as a macroblock (MB), may be sub-divided into sub-blocks of fixed or varying sizes. That is, the coded unit may contain sub-blocks of the same or different sizes. In general, MBs and the various sub-blocks may be considered to be video blocks. Thus, MBs may be considered to be video blocks, and if partitioned or sub-partitioned, MBs can themselves be considered to define sets of video blocks.

To encode the video blocks, video encoder 20 may generate a prediction block that is a predicted version of the video block currently being coded. For intra-coding, which relies on spatial prediction to reduce or remove spatial redundancy in video data within a given coded unit, e.g., frame or slice, video encoder 20 forms a spatial prediction block based on one or more previously encoded blocks within the same frame as the block currently being coded. For inter-coding, which relies on temporal prediction to reduce or remove temporal redundancy within adjacent frames of the video sequence, video encoder 20 may generate a temporal prediction block based on one or more previously encoded blocks from other frames within the coded unit. Video encoder 20 may subtract the prediction block from the original video block to form a residual block. The residual block includes a set of pixel difference values that quantify differences between pixel values of the original video block and pixel values of the generated prediction block.

Following generation of the residual block, video encoder 20 may apply transform, quantization and entropy coding processes to further reduce the bit rate associated with communication of the residual block. The transform techniques, which may include an integer transform, discrete cosine transform (DCT), directional transform, or wavelet transform may change a set of pixel values into transform coefficients, which represent the energy of the pixel values in the frequency domain. Quantization is applied to the transform coefficients, and generally involves a process that limits the number of bits associated with any given coefficient. The video encoder entropy encodes the vector of quantized transform coefficients to further compress the residual data. Video encoder 20 may entropy encode the quantized coefficients using any of a variety of entropy coding methodologies, such as variable length coding (VLC), context adaptive VLC (CAVLC), arithmetic coding, context adaptive binary arithmetic coding (CABAC), run length coding or the like.

Source device 12 transmits the encoded video data to destination device 14 via transmitter 22 and channel 16. Communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting encoded video data from source device 12 to destination device 14. In other aspects, however, source device 12 may not include a transmitter 22. Instead, source device 12 may store the encoded video data locally for later use, e.g., for later displaying via a display coupled to source device 12. For instances, source device 12 may be a camcorder that captures and encodes the video data and, at a later time, is connected to a display via one or more cables to display the encoded video data.

Destination device 14 may include a receiver 24, video decoder 26, histogram enhancement unit 27 and display device 28. Receiver 24 receives the encoded video data from source device 12 via channel 16. Video decoder 26 applies entropy decoding to decode the encoded video data. Video decoder 26 may perform inverse entropy coding operations to obtain the residual pixel values. In particular, video decoder 26 may perform entropy decoding to obtain the quantized residual coefficients, followed by inverse quantization to obtain the transform coefficients, followed by inverse transformation to obtain the residual block of pixel difference values. Video decoder 26 may also generate a prediction video block based on prediction information and/or motion information associated with the block. Video decoder 26 then adds the prediction video block to the corresponding residual block in order to generate the reconstructed video block. The reconstructed video block represents a two-dimensional block, e.g., array, of pixel values that represent intensity and/or color. In this manner, video decoder 26 decodes the frames to the pixel domain, i.e., sets of pixel values, for operations performed by histogram enhancement unit 27.

Histogram enhancement unit 27 performs content adaptive histogram enhancement in accordance with the techniques of this disclosure. In particular, histogram enhancement unit 27 generates a histogram that represents a distribution of pixel values within the frame. In other words, the histogram indicates a relative occurrence of each possible pixel value within the frame. To generate the histogram, histogram enhancement unit 27 may separate the pixel values of the frame into one or more groups, sometimes referred to as bins. In some cases, each of the bins may correspond to a particular one of the possible pixel values. In the case of an 8-bit grayscale image, for example, each bin may correspond to a value ranging from 0-255. In other words, there may be 256 separate bins, each of which corresponds to only one value. Alternatively, the bins may correspond to a subset of the possible pixel values. For example, each of the bins may correspond to a particular number of consecutive pixel values, e.g., sixty-four bins that each correspond to four consecutive pixel values. Although described in terms of representing each pixel using 8-bit grayscale, more or less bits may be used to represent the pixels.

Histogram enhancement unit 27 analyzes the histogram, e.g., the distribution of pixel values of the frame, to classify the frame into one a plurality of content classes that represent various levels of brightness, contrast, or the like. Histogram enhancement unit 27 may analyze a shape of the histogram to classify the frame into one of the plurality of content classes. For example, the existence and location of one or more peaks within the histogram may be indicative of the type of content within the frame. Additionally, the width of the identified peaks may also be indicative of the type of content within the frame. As another example, an average brightness of the pixel values of the frame may also be indicative of the type of content within the frame. Based on these one or more characteristics of the histogram, histogram enhancement unit 27 may classify the frame into the appropriate content class.

After classifying the frame into one of the content classes, histogram enhancement unit 27 may adjust the pixel values of the frame based on the content class of the frame to enhance a subjective visual quality of the frame. For example, histogram enhancement unit 27 may adjust the pixel values to increase the brightness of the frame or increase the contrast of the frame to enhance the visual scene. Histogram enhancement unit 27 may adjust the pixel values of the frame using a pixel mapping function that maps the decoded pixel values of the frame to new pixel values. As will be described in greater detail below, the pixel mapping function may be capable of adjusting the pixel values of the frame differently based on the content class of the frame. In this manner, the histogram enhancement is adaptive based on the content of the frame.

Destination device 14 may display the reconstructed video blocks to a user via display device 28. Display device 28 may comprise any of a variety of display devices such as a cathode ray tube (CRT), a liquid crystal display (LCD), a plasma display, a light emitting diode (LED) display, an organic LED display, or another type of display unit.

In some cases, source device 12 and destination device 14 may operate in a substantially symmetrical manner. For example, source device 12 and destination device 14 may each include video encoding and decoding components. Hence, system 10 may support one-way or two-way video transmission between devices 12, 14, e.g., for video streaming, video broadcasting, or video telephony. A device that includes video encoding and decoding components may also form part of a common encoding, archival and playback device such as a digital video recorder (DVR).

Video encoder 20 and video decoder 26 may operate according to any of a variety of video compression standards, such as such as those defined by the Moving Picture Experts Group (MPEG) in MPEG-1, MPEG-2 and MPEG-4, the ITU-T H.263 standard, the Society of Motion Picture and Television Engineers (SMPTE) 421M video CODEC standard (commonly referred to as “VC-1”), the standard defined by the Audio Video Coding Standard Workgroup of China (commonly referred to as “AVS”), as well as any other video coding standard defined by a standards body or developed by an organization as a proprietary standard. Although not shown in FIG. 1, in some aspects, video encoder 20 and video decoder 26 may each be integrated with an audio encoder and decoder, respectively, and may include appropriate MUX-DEMUX units, or other hardware and software, to handle encoding of both audio and video in a common data stream or separate data streams. In this manner, source device 12 and destination device 14 may operate on multimedia data. If applicable, the MUX-DEMUX units may conform to the ITU H.223 multiplexer protocol, or other protocols such as the user datagram protocol (UDP).

In some aspects, for video broadcasting, the techniques described in this disclosure may be applied to enhanced H.264 video coding for delivering real-time video services in terrestrial mobile multimedia multicast (TM3) systems using the Forward Link Only (FLO) Air Interface Specification, “Forward Link Only Air Interface Specification for Terrestrial Mobile Multimedia Multicast,” published in July 2007 as Technical Standard TIA-1099 (the “FLO Specification”). That is to say, communication channel 16 may comprise a wireless information channel used to broadcast wireless video information according to the FLO Specification, or the like. The FLO Specification includes examples defining bitstream syntax and semantics and decoding processes suitable for the FLO Air Interface.

Alternatively, video may be broadcasted according to other standards such as DVB-H (digital video broadcast-handheld), ISDB-T (integrated services digital broadcast-terrestrial), or DMB (digital media broadcast). Hence, source device 12 may be a mobile wireless terminal, a video streaming server, or a video broadcast server. However, techniques described in this disclosure are not limited to any particular type of broadcast, multicast, or point-to-point system. In the case of broadcast, source device 12 may broadcast several channels of video data to multiple destination devices, each of which may be similar to destination device 14 of FIG. 1. Thus, although a single destination device 14 is shown in FIG. 1, for video broadcasting applications, source device 12 would typically broadcast the video content simultaneously to many destination devices.

In other examples, transmitter 22, communication channel 16, and receiver 24 may be configured for communication according to any wired or wireless communication system, including one or more of a Ethernet, telephone (e.g., POTS), cable, power-line, and fiber optic systems, and/or a wireless system comprising one or more of a code division multiple access (CDMA or CDMA2000) communication system, a frequency division multiple access (FDMA) system, an orthogonal frequency division multiple (OFDM) access system, a time division multiple access (TDMA) system such as GSM (Global System for Mobile Communication), GPRS (General packet Radio Service), or EDGE (enhanced data GSM environment), a TETRA (Terrestrial Trunked Radio) mobile telephone system, a wideband code division multiple access (WCDMA) system, a high data rate 1×EV-DO (First generation Evolution Data Only) or 1×EV-DO Gold Multicast system, an IEEE 802.18 system, a MediaFLO™ system, a DMB system, a DVB-H system, or another scheme for data communication between two or more devices.

Source device 12, destination device 14 or both may be a wireless or wired communication device as described above. Also, source device 12, destination device 14 or both may be implemented as an integrated circuit device, such as an integrated circuit chip or chipset, which may be incorporated in a wireless or wired communication device, or in another type of device supporting digital video applications, such as a digital media player, a personal digital assistant (PDA), a digital video camera, a digital television, or the like.

Video encoder 20, video decoder 26 and histogram enhancement unit 27 each may be implemented as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 26 may be included in one or more encoders or decoders, either of which may be integrated as part of a combined encoder/decoder (CODEC) in a respective mobile device, subscriber device, broadcast device, server, or the like.

In addition, source device 12 and destination device 14 each may include appropriate modulation, demodulation, frequency conversion, filtering, and amplifier components for transmission and reception of encoded video, as applicable, including radio frequency (RF) wireless components and antennas sufficient to support wireless communication. For ease of illustration, however, such components are summarized as being transmitter 22 of source device 12 and receiver 24 of destination device 14 in FIG. 1. In the example illustrated in FIG. 1, the histogram enhancement unit 27 is located within destination device 14, e.g., within a post-processing unit (not shown) of video decoder 26. In other aspects, however, histogram enhancement unit 27 may be located within source device 12, e.g., within a pre-processor or video front end (not shown) of source device 12. Moreover, the enhancement techniques of this disclosure are described in the context of enhancing digital video data. However, the enhancement techniques may also be applied to still images, e.g., images captured with a digital camera. As such, the image enhancement techniques of this disclosure may be applied to any sort of digital image data, including frames of digital video data and frames of digital still image data.

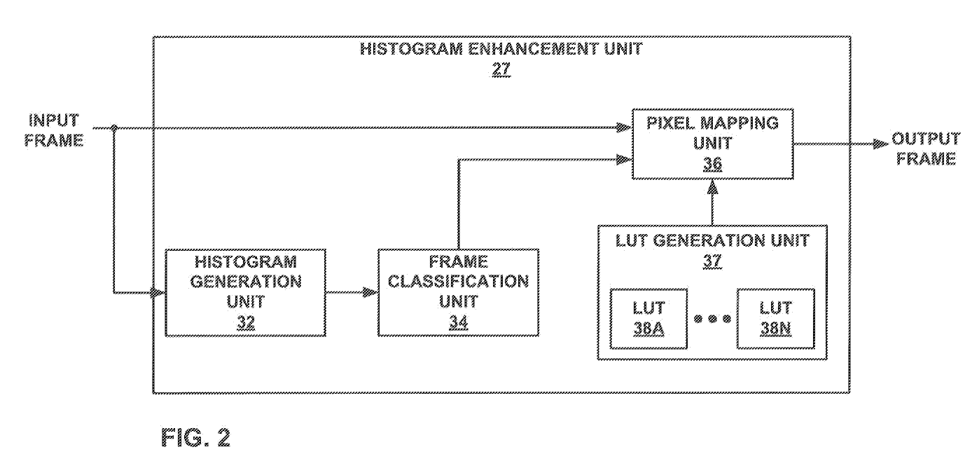

FIG. 2 is a block diagram illustrating a histogram enhancement unit 27 in further detail. Histogram enhancement unit 27 includes a histogram generation unit 32, frame classification unit 34, a pixel mapping unit 36, a look-up table (LUT) generation unit 37, and one or more LUTs 38A-38N (collectively, “LUTs 38”). As described above, histogram enhancement unit 27 may be implemented within either destination device 14, e.g., as a post processing element, or within source device 12, e.g., as a pre-processing element. In other aspects, histogram enhancement unit 27 may be implemented within an encoding unit and/or decoding unit.

Histogram generation unit 32 obtains a frame of digital image data, e.g., a frame of digital video data or a frame of digital still image data, and generates a histogram that represents the distribution of the pixel values within the frame. The digital image data of the frame may be an array of raw pixel data, e.g., pixel values that represent an intensity and/or a color for a specific location in the visual scene. To generate the histogram that indicates a relative occurrence of each possible pixel value within the frame, histogram generation unit 32 may separate the pixel values of the frame into one or more groups, sometimes referred to as bins.

In some cases, each of the bins may correspond to a particular one of the possible pixel values. In the case of an 8-bit grayscale image, for example, each bin may correspond to a value ranging from 0-255, such that there are 256 separate bins each corresponding to a single pixel value. Alternatively, the bins may correspond to a subset of the possible pixel values. For example, each of the bins may correspond to a particular number of consecutive pixel values, e.g., 128 bins that each correspond to two consecutive pixel values. Although described in terms of representing each pixel using 8-bit grayscale, more or less bits may be used to represent the pixel values.

Frame classification unit 34 analyzes the histogram of the frame to characterize the content of the visual scene of the frame. Frame classification unit 34 may, for example, generate various statistics associated with the histogram and analyze the histogram statistics to classify the frame into one of the plurality of content classes. Each of the content classes may correspond with particular characteristics of the visual scene, e.g., brightness and contrast. For example, a first content class may correspond with a first brightness level (e.g., a low brightness or dark level), a second content class may correspond with a second brightness level (e.g., a high brightness or bright level), a third content class may correspond with a third brightness level (e.g., a middle brightness level), a fourth content class may correspond with a first contrast level (e.g., undercontrasted level) a fifth content class may correspond with a second contrast level (e.g., overcontrasted level), and the like.

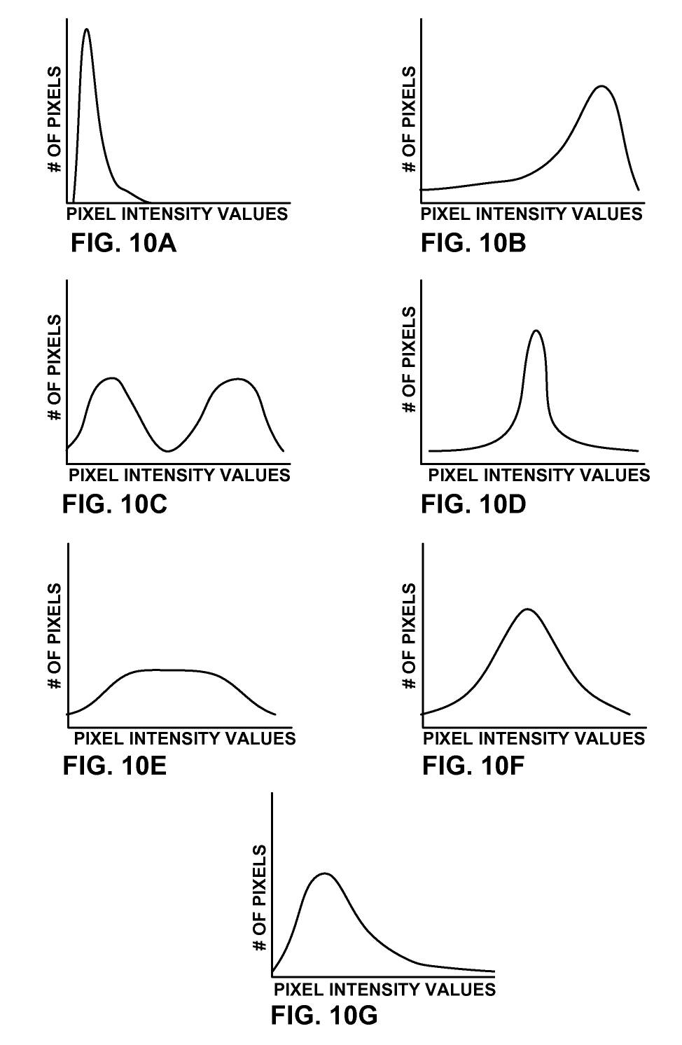

Frame classification unit 34 may, for example, analyze the histogram statistics to identify the existence and location of one or more peaks within the histogram. The existence and location of one or more peaks within the histogram may be indicative of the type of content within the frame. The peaks within the histogram may correspond to pixel value ranges corresponding to high concentrations of pixels within the frame. For instance, a histogram with a single peak located among the lower pixel values may represent a dark image. Such a histogram is illustrated and described in more detail in FIG. 10A below. Additionally, frame classification unit 34 may analyze a width of the identified peaks, which also may be indicative of the type of content within the frame. In this manner, frame classification unit 34 may analyze the histogram statistics to characterize a shape of the histogram and classify the frame into one of the content classes based on the shape of the histogram. Additionally, or alternatively, frame classification unit 34 may analyze an average brightness of the pixel values of the histogram to classify the frame into a corresponding content class. The average brightness of the pixel values may also be indicative of the type of content within the frame. For example, when the average brightness of the histogram is less than or equal to a first threshold value frame classification unit 34 may determine the content of the frame is a dark and when the average brightness is greater than or equal to a second threshold frame classification unit 34 may determine the content of the frame is bright.

To analyze the histogram of the frame, frame classification unit 34 may, in some aspects, compute statistics of the histogram and analyze the histogram statistics to classify the frame into one of the content classes. The histogram statistics may include a number of variables associated with the histogram. Frame classification unit 34 may compute one or more quantiles of the histogram for use in determining the characteristics of the histogram.

Quantiles represent locations along the histogram at which a fraction or percent of pixel values of the histogram fall below a particular pixel value. In one aspect, frame classification unit 34 computes at least a 0.1 quantile, 0.3 quantile, 0.6 quantile and 0.9 quantile. The 0.1 quantile pixel value represents the pixel value at which 10% of the pixel values of the histogram fall below the 0.1 quantile pixel value and 90% of the pixel values of the histogram are above the 0.1 quantile pixel value. The 0.3 quantile represents the pixel value at which 30% of the pixel values of the histogram fall below the 0.3 quantile pixel value and 70% of the pixel values of the histogram are above the 0.3 quantile pixel value. The 0.6 quantile pixel value represents the pixel value at which 60% of the pixel values of the histogram fall below the 0.6 quantile pixel value and 40% of the pixel values of the histogram are above the 0.6 quantile pixel value. The 0.9 quantile pixel value represents the pixel value of the histogram at which 90% of the pixel values of the histogram fall below the 0.9 quantile pixel value and 10% of the pixel values of the histogram are above the 0.6 quantile pixel value.

Using the computed quantile pixel values, frame classification unit 34 may compute additional histogram statistics, e.g., variables. In one aspect, frame classification unit 34 may compute a variable midPeak according to equation (1):

midPeak=max(q0.9−q0.6, q0.6−q0.3), (1)

where midPeak represents the middle region with a maximum variance, max(x, y) is a function that selects the variable x when x>y and selects the variable y when x<y, q0.9 is the 0.9 quantile pixel value, q0.6 is the 0.6 quantile pixel value, q0.3 is the 0.3 quantile pixel value. Thus, equation (1) selects the larger of the difference between the 0.9 quantile pixel value and the 0.6 quantile pixel value and the difference between the 0.6 quantile pixel value and the 0.3 quantile pixel value.

Frame classification unit 34 may also compute additional variables using the quantile pixel values. For example, in addition to the middle peak (midPeak), frame classification unit 34 may compute a left peak value (leftPeak) and a right peak value (rightPeak). The left and right peak values may be computed using equations (2) and (3) below.

leftPeak=q0.1−min (2)

rightPeak=max−q0.9 (3)

In equations (2) and (3) above, q0.1 represents the 0.1 quantile pixel value, min is the minimum pixel value of the frame, max is the maximum pixel value of the frame and q0.9 is the 0.9 quantile pixel value. Thus, the left peak is computed as a difference between the pixel value of the 0.1 quantile pixel value and the minimum pixel value of the frame and the right peak is computed as a difference between the maximum pixel value of the frame and the pixel value of the 0.9 quantile pixel value.

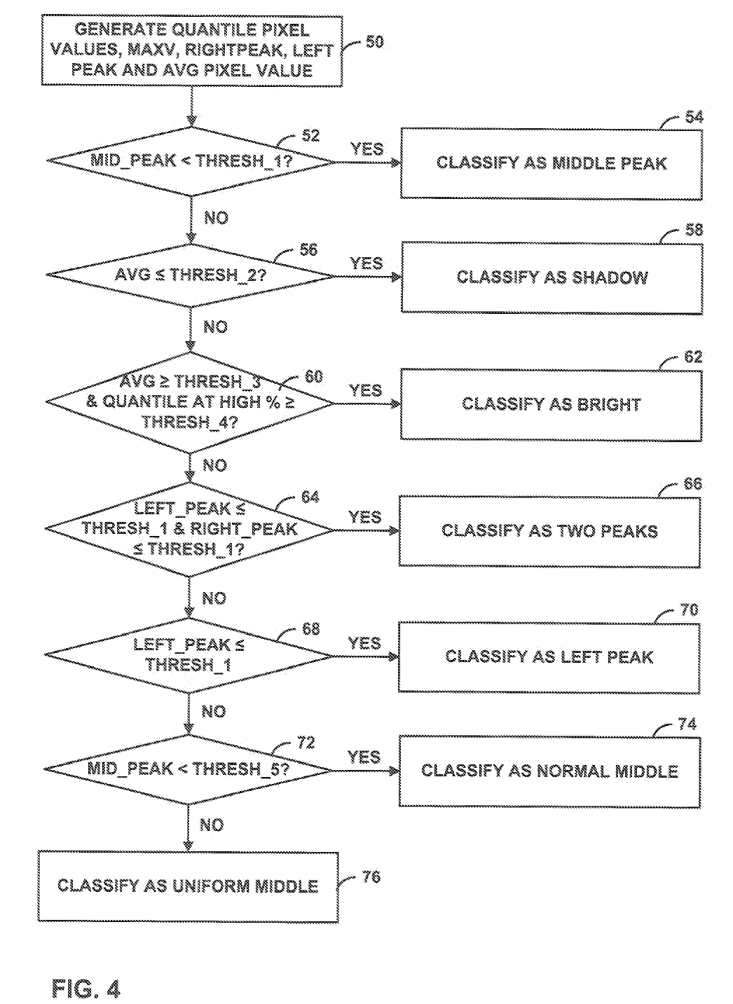

Frame classification unit 34 may also compute an average pixel value of the histogram. The average pixel value may be computed as a mean pixel value, median pixel value or mode pixel value. Frame classification unit 34 analyzes the computed variables to classify the frame into one of the content classes. Frame classification unit 34 may compare the computed variables to corresponding thresholds, as described in detail in the flow chart of FIG. 4, to classify the frame into the content classes. In one instance, frame classification unit 34 may classify the frame into one of seven content classes, which may include a middle peak, shadow, bright, two peaks, left peak, normal middle and uniform middle. The middle peak may represent bright and low contrast images, the shadow content class may represent very dark images with a narrow (small) pixel distribution range, the bright content class may represent very bright images with a narrow (small) pixel distribution range, the two peaks content class may represent high-contrast images, the left peak content class may represent dark images with a wide pixel distribution range, the right peak content class may represent bright images with a wide pixel distribution range, the normal middle content class may represent images with regular brightness but the contrast could be enhanced, and the uniform middle content class represents an almost ideal image that may need to be slightly spread out in its histogram.

Pixel mapping unit 36 maps the pixel values of the frame to new pixel values to enhance the subjective visual quality of the frame. Pixel mapping unit 36 obtains a context class identifier from frame classification unit 34 that identifies a content class associated with the frame and maps the decoded pixel values to new pixel values based on the content class associated with the frame. In one aspect, pixel mapping unit 38 may select one of LUTs 38 based on the content class identifier associated with the frame. In particular, LUT generation unit 37 may generate LUTs 38 that map each of the possible pixel values to new pixel values and pixel mapping unit 38 may select the appropriate one of LUTs 38.

When pixels are represented in 8-bit color, for example, LUTs 38 may include 256 mappings. LUTs 38 may, in some instances, map only a portion of the possible decoded pixel values to new pixel values. Each of LUTs 38 may correspond with a particular one of the content class identifiers. Alternatively, LUT generation unit 37 may generate LUTs 38 on the fly to reduce the memory resources required to maintain LUTs 38. For example, LUT generation unit 37 may maintain a single LUT 38 and update the mapping values of the single LUT 38 when the content class of the current frame is different than the content class of the previous frame.

In one aspect, LUT generation unit 37 uses a frame-level mapping function that is adaptive based on the classification of the frame to generate LUTs 38. Because average brightness and contrast are two of the most important factors in evaluating visual quality of a frame, the mapping function may increase the average brightness, contrast, or both. As an example, for frames classified in a content class having low average brightness (e.g., shadow content class), the mapping function may increase the brightness of the frame to reveal more details of the visual scene. As another example, for frames classified in a content class with very bright source and very dark areas (e.g., two peak content class), the mapping function may reduce the contrast by brightening the dark areas and darkening the bright areas. As another example, for frames classified in a content class with a limited range of luminance (e.g., a middle peak content class), the mapping function may extend the luminance range and increase the average brightness. As such, it may be desirable to enhance the frames differently depending on the characteristics of the visual scenes of the frames, e.g., based on the content class of the frame.

Two mapping functions are provided in equations (4) and (5) below.

$$\begin{matrix}y = {x}^{β} & ( 4 ) \\ y = \frac{log ( x ( ϕ - 1 ) + 1 )}{log ( ϕ )} & ( 5 )\end{matrix}$$

These mapping functions enhance the frame by mapping an input pixel value x (e.g., the decoded pixel value) to an output pixel value y (e.g., a new pixel value). Parameters β and φ represent pre-defined variables. Mapping functions (4) and (5) may have good performance in revealing details in the dark areas (e.g., areas with small pixel values) with little or no saturation appearing in the enhanced frame. However, these functions tend to reduce the contrast of the image in midtone (e.g., mid-range pixel values) or bright areas (e.g., areas with large pixel values), which is undesirable. Because a video frame captured in real lighting condition may have dark, midtone and bright areas, and these pixel value ranges should be corrected in different manners, mapping functions (4) and (5) may not provide the optimal histogram enhancement results due to their inability to properly adjust different luminance ranges in the frame. As one example, pixel intensity values in the range of [0, 50] are considered to be “dark,” pixel intensity values in the range of [60, 180] are considered to be “midtone,” and pixel intensity values in the range of [200, 255] are considered to be “bright.” The remainder of possible pixel intensity values may be considered to be within a transition area.

LUT generation unit 37 may, in some instances, utilize a mapping function that is capable of adjusting different luminance ranges in different manners based on the content class of the frame. In one aspect, the mapping function may be a non-linear Gamma curve to reduce negative impacts on visual image quality that may occur during histogram enhancement, e.g., reduced contrast in midtone and bright areas. The non-linear Gamma curve is represented by equation (6) below.

y=x^{1/(1+G(x))}, (6)

where G(x)=ƒ₁(x)+ƒ₂(x)+ƒ₃ (x), ƒ₁(x)=1+α cos(πx/2xₘ), ƒ₂(x)=(K(x)+b)cos α+x sin(α), K(x)=ρ sin(4π/255), α=arctan(−b/xₘ), ƒ₃ (x)=R(x)cos(3πx/255), R(x)=c|x/xₘ−1|, xₘ a middle pixel value of the available range of pixel values, and a, b, c, and ρ are variables.

The non-linear gamma curve of equation (6) is quite complex and difficult to implement within a device with limited processing resources and/or limited memory, such as a wireless or mobile communication device. To reduce the complexity of this function, the non-linear Gamma curve of equation (6) may be simplified based on an algorithm working range and Taylor Expansions. For example, variable b is typically less than 0.3 and xₘ, for an 8-bit color depth image, is approximately 128, and τ=−b/xₘ is very close to zero (<0.0025). Since |arctan(x)−x|≦10⁻⁶, for |x|<0.01, we have arctan(τ)=τ. Also, according to Taylor Expansion, we have sin(τ)=τ and cos(τ)=1, for very small value τ. Using these simplifications, equation (6) may be approximated as:

ƒ_{b}(x)=x^{γ}, (7)

γ=1/(a cos(πx)+ρ sin(4πx)+c|x/xₘ−1|cos(3πx)−bx/xₘ+b+1), (8)

where xε[0:1]. The parameter c|x/xₘ−1| may limit the cosine function amplitude in the midtone area and −bx/xₘ may ensure that the overall trend of the mapping function decreases (i.e., the shadow area is boosted the most).

The mapping function of equations (7) and (8) has the flexibility to adjust pixel values of different luminance ranges in the histogram of the frame based on the content classes. In particular, pixel mapping unit 36 may adjust one or more of variables a, b, c, ρ and xₘ, based on the content class of the frame. For example, a small a value increase the transition from shadow to midtone, a larger b value reduces the average brightness in the midtone and bright area, a small c value results in the small overall-variation of the mapping function, and a small ρ value results in less correction in the midtone area. To ensure that the average brightness of the frame is not reduced, pixel mapping unit 36 may keep γ>0. Based on the above constraints and experimental results, a recommended range for all of these variables is a+b+c+ρ<1.

Adjusting the variables of the mapping function of equations (7) and (8) enables the mapping function to be capable of changing convexity at least two times to smoothly transition from the dark region of the histogram to the midtone region of the histogram and from midtone region of the histogram to bright region of the histogram. Additionally, the mapping function may change convexity within the midtone region of the histogram. As such, the non-linear Gamma curve includes an element that changes convexity three times (e.g., sin(4πx) in equation (8)), one changes convexity twice (e.g., cos(3πx) in equation (8)), and one changes convexity once (e.g., cos(πx) in equation (8)), with different amplitudes, (e.g., a, ρ, and c|x/xₘ−1|, respectively).

Pixel mapping unit 36 may further modify the mapping function of equation (7) to better increase contrast. In particular, pixel mapping unit 36 may use equation (9) below as the mapping function.

ƒ_{c}(x)=2x−x^{γ} (9)

Alternatively, pixel mapping unit 36 may use a mapping function that is a weighted combination of the brightness enhancement function of equation (7) and the contrast enhancement function of equation (9), as shown in equation (10).

y=αƒ_{c}(x)+(1−α)ƒ_{b}(x), (10)

where α is an adjustable weight between 0≦α≦1. Pixel mapping unit 36 may select α value for a based on the content class provided by frame classification unit 34. Pixel mapping unit 36 may select a larger value of α when the content class requires more contrast adjustment than brightness adjustment and select a smaller value of α when the content class requires more brightness adjustment than contrast adjustment.

Adjusting the luminance pixel values of the frame may affect the color of the frame. For example, in the Y-Cb-Cr color space, for example, luma and chroma are correlated. Therefore, pixel mapping unit 36 may additionally adjust color, e.g., chroma, pixel values within the frame. In one instance, pixel mapping unit 36 may adjust color pixel values (e.g., Cb and Cr chrominance values) using a constant scaling factor. The constant scaling factor may be derived based on the scaling of the luma component by the pixel mapping function. For example, pixel mapping function may compute the scaling factor (r) used to scale the chroma components as a ratio of the integration of the pixel mapping function ƒ(x) over that of function y=x, expressed below as equation (11).

$$r = \frac{{\int }_{0}^{a} f ( x )}{{\int }_{0}^{a} x} , \qquad ( 11 )$$

where a is the chop point. That chop point may be a value that is close to or equal to a maximum pixel value within the range of possible pixel values. As the value of a approaches the maximum possible pixel value of the range, the value of scaling factor (r) is smaller, and less adjustment is made to the chroma values. In accordance with equation (11), the scaling factor r used by pixel mapping unit 36 to adjust the color component of the frame increases with increases in the amount scaling of the luma component of the frame. Pixel mapping unit 36 may include an upper bound for the scaling factor to reduce the likelihood of over-saturating the color component of the frame. For example, the upper bound for the scaling factor may be approximately 1.3.

In some instances, frame classification unit 34 may classify two consecutive, e.g., neighboring, frames in a video sequence into two different content classes when the computed parameters of the histogram are close to the content class thresholds. As an example, the histogram of a first frame may have similar histogram statistics to a histogram of a second, consecutive frame, but the first frame may have a mean pixel value that is slightly less than a mean threshold value corresponding to a shadow content class and the histogram of a second, consecutive frame may have a mean pixel value that is slightly larger than the mean threshold value corresponding to the shadow content class. As such, frame classification unit 34 may classify the first frame as a shadow content class and classify the second frame as a different context class, e.g., a normal middle content class.

Because the first and second consecutive frames correspond with different content classes, pixel mapping unit 36 adjusts the pixel values of each of the frames differently based on the content class of the frames. Thus, even though the first and second frames are similar, pixel mapping unit 36 adjusts the pixel values of the frames differently. This may result in undesirable artifacts, such as flickering, in the video sequence. To reduce the likelihood of the undesirable artifacts, frame classification unit 34 may, in some instances, provide a content class identifier to pixel mapping unit 36 that is different than the content class to which frame classification unit 34 classified the current frame. In other words, the content class identifier provided to pixel mapping unit 36 may correspond to a different content class than the content class to which the frame was classified, such as the content class of the previous frame of the video sequence.

After classifying the frame as one of the corresponding content classes, frame classification unit 34 may compare the histogram information of the current frame and the previous frame to determine the content class of the current frame to determine whether the frames are similar. For example, frame classification unit 34 may compare the quantile pixel values, average pixel values, middle peak values, right peak values, left peak values, or other variables associated with the histograms of the current frame and the previous frame. Frame classification unit 34 may, for example, compute differences between one or more of the parameters of the histogram information, and compare the computed differences to a threshold to determine whether the frames are similar. For example, frame classification unit 34 may increment a similarity count by one for each variable that has a difference that is less than a pre-defined threshold (e.g., 5). Frame classification unit 34 may adjust the similarity count based on the difference of each of the variables (e.g., the quantile pixel values, average pixel values, middle peak values, right peak values, left peak values) with similar variables of the previous frame. If the final similarity count is greater than the majority of the total number of variables (e.g., four out of seven), frame classification unit 34 considers the current frame and the previous frame to be similar.

Frame classification unit 34 may also determine whether a scene change occurs between the previous frame and the current frame. In one aspect, frame classification unit 34 may determine whether a scene change occurs based on the correlation between current and previous histograms. For example, frame classification unit 34 may determine whether a scene change occurs using the equation

$${SIM}_{Y} = \frac{{\vec{H}}_{Y , i} \cdot {\vec{H}}_{Y , i - 1}}{‖ {\vec{H}}_{Y , i} ‖ \cdot ‖ {\vec{H}}_{Y , i - 1} ‖} , \qquad ( 12 )$$

where \vec{H}_{Y,i} and \vec{H}_{Y,i-1} are the histograms of current and previous luminance pixel values. The value of SIM_{Y} may be compared to a threshold to determine whether a scene change occurred. Frame classification unit 34 may, however, use other techniques for detecting a scene change.

When frame classification unit 34 determines that the current frame and the previous frame are not similar or that there is a scene change, frame classification unit 34 provides pixel mapping unit 36 with the content class identifier corresponding with the content class of the current frame. However, when frame classification unit 34 determines that the frames are similar and that no scene change occurred, frame classification unit 34 provides pixel mapping unit 36 with the content class identifier of the previous frame. In this manner, pixel mapping unit 36 adjusts the pixel values of the current frame in the same manner as the pixel values of the previous frame, thus resulting in a reduction of visual artifacts in the video sequence. Frame classification unit 34 may not change the content class associated with the current frame. In other words, the content class associated with the current frame remains the same. Instead, the frame classification unit 34 simply provides pixel mapping unit with a content class identifier that is different than that of the current frame.

Besides improving visual quality, providing pixel mapping unit 36 the content class of the previous frame when the current and previous frames are similar and no scene change has occurred may reduce the frequency with which the pixel mapping LUT 38 is updated. For example, in instances in which the LUT 38 is updated only when the content class changes, the LUT 38 may remain the same because although the content class of the current frame is different from that of the previous frame, the pixel values of the frame are adjusted in the same manner as the pixel values of the previous frame. The techniques described above may be viewed as temporal filtering.

Alternatively, when the current frame and the previous frame are determined to be similar, frame classification unit 34 may provide pixel mapping unit 36 with content class identifiers of both the current frame and the previous frame. Pixel mapping unit 36 may map the pixel values of the current frame using a combination of the mapping function of the previous frame and the mapping function of the current frame. In this manner, the combined mapping function of the current and previous frame reduces visual artifacts in the output image. For example, a look-up-table to be used for the pixel mapping may be generated as a combination of a look-up table for mapping the content class of the current frame and a look-up table for mapping the pixel values of the content class of the previous frame. The combining of the look-up tables may be performed in accordance with blending coefficient alpha, as shown in the equation below

LUT_{Combined}=alpha*LUT_{Previous}+(1−alpha)*LUT_{Current} (13)

The value of alpha may be equal to zero when the frames are not similar or there is a scene change and equal to one when the frames are similar and there is no scene change. In other instances, alpha may take on a value between zero and one to combine the values of the two LUTs, which provides a smooth transition between histogram enhanced frames

Histogram generation unit 32, frame classification unit 34 and pixel mapping unit 36 may be implemented in hardware, software, firmware, or any combination thereof. In one aspect, for example, histogram generation unit 32 and pixel mapping unit 36 may be implemented within hardware while frame classification unit 34 is implemented in software. Depiction of different features as units is intended to highlight different functional aspects of the device illustrated and does not necessarily imply that such units must be realized by separate hardware or software components. Rather, functionality associated with one or more units may be integrated within common or separate hardware or software components.

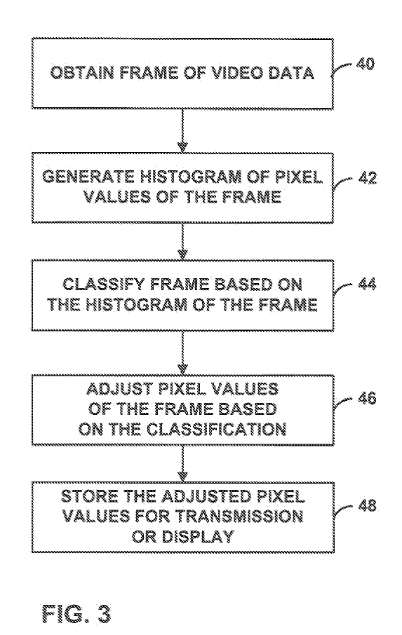

FIG. 3 is a flow diagram illustrating an example operation of a histogram enhancement unit 27 performing histogram enhancement in accordance with the techniques described in this disclosure. Histogram generation unit 32 obtains a frame of video data (40). The video data of the frame may be an array of raw pixel data, e.g., pixel values that represent an intensity and/or a color for a specific point in the visual scene.

Histogram generation unit 32 generates a histogram that represents the distribution of the pixel values within the frame (42). In the Y-Cb-Cr color space, for example, histogram generation unit 32 may generate a histogram of luminance pixel values of the frame. To generate the histogram that indicates a relative occurrence of each possible luminance pixel value within the frame, histogram generation unit 32 may arrange the pixels of the frame into one or more groups, sometimes referred to as bins, based on the pixel values of the pixels. Each of the bins may correspond to one or more possible pixel values. Histogram generation unit 32 may generate the histogram using the total number of pixels of the bins.

Frame classification unit 34 classifies the frame based at least on the histogram of the frame (44). Based on a shape of the histogram of the frame, for example, frame classification unit 34 may classify the frame into one of a plurality of content classes that correspond with particular characteristics of the visual scene, e.g., brightness and contrast. For example, frame classification unit 34 may analyze statistics associated with the histogram to identify the existence and location of one or more peaks within the histogram to classify the frame into a corresponding content class. Additionally, or alternatively, frame classification unit 34 may analyze an average brightness of the pixel values of the histogram to classify the frame into a corresponding content class.

To analyze the histogram of the frame, frame classification unit 34 may, in some aspects, compute a number of variables associated with the histogram and analyze those variables to determine characteristics of the histogram. Frame classification unit 34 may analyze the computed variables to classify the frame into one of the content classes. Frame classification unit 34 may compare the computed variables to corresponding thresholds, as described in detail in the flow chart of FIG. 4, to classify the frame into the appropriate content class.

Frame classification unit 34 may compute one or more quantiles of the histogram for use in determining the characteristics of the histogram. Quantiles represent locations along the histogram at which a fraction or percent of pixel values of the histogram fall below a particular pixel value. In one aspect, frame classification unit 34 computes at least a 0.1 quantile, 0.3 quantile, 0.6 quantile and 0.9 quantile as described in more detail with respect to FIG. 1. Using the computed quantile pixel values, frame classification unit 34 may compute additional variables associated with the histogram, such as a middle peak value (e.g., midPeak of equation (4)), left peak value (e.g., leftPeak of equation (5)), right peak value (rightPeak of equation (6)), average pixel value and the like.

Pixel mapping unit 36 adjusts the luminance pixel values of the frame based on the content class of the frame (46). Pixel mapping unit 36 may, for example, select one of a plurality of LUTs 38, corresponding to the content class of the frame and adjust the pixel values of the frame by mapping current pixel values to new pixel values in accordance the selected LUT 38. Alternatively, pixel mapping unit 36 or other unit may generate the LUT 38 for pixel mapping on the fly. In either case, the LUTs 38 are generated using a frame-level mapping function that is adaptive based on the content class of the frame. The mapping function may also be capable of adjusting different luminance pixel value ranges differently based on the content class of the frame. For example, the mapping function may be an approximation of a non-linear Gamma curve (e.g., any of equations (7), (9) and (10)) that is capable of adaptively adjusting various luminance pixel value ranges in different manners by adjusting the variables of the function, e.g., a, b, c, ρ and xₘ.

Adjusting the luminance pixel values of the frame may affect the color components of the frame. For example, in the Y-Cb-Cr color space, for example, luma and chroma are correlated. Therefore, pixel mapping unit 36 may additionally adjust pixel values of the color components of the frame. In one instance, pixel mapping unit 36 may adjust pixel values of the color components (e.g., Cb and Cr chrominance values) using a constant scaling factor. The constant scaling factor may be derived based on the degree of scaling of the luminance pixel values. For example, pixel mapping unit 36 may compute the scaling factor (r) used to scale the pixel values of the color components as a ratio of the integration of the pixel mapping function ƒ(x) over that of function y=x, expressed in equation (11) above. In some instances, pixel mapping unit 36 may include an upper bound for the scaling factor to reduce the likelihood of over-saturating the color component of the frame. Histogram enhancement unit 27 stores the adjusted pixel values for transmission and/or display (48).

FIG. 4 is a flow diagram illustrating an example operation of a frame classification unit 34 classifying a frame into one of a plurality of content classes. Initially, frame classification unit 34 computes a number of variables associated with the histogram (50). Frame classification unit 34 may compute one or more quantiles of the histogram that represent locations along the histogram at which a fraction or percent of pixel values of the histogram fall below a particular pixel value. In one aspect, frame classification unit 34 computes at least a 0.1 quantile, 0.3 quantile, 0.6 quantile, 0.8 quantile and 0.9 quantile. Frame classification unit 34 may compute additional variables associated with the histogram using the computed quantile pixel values, such as a middle peak value (e.g., midPeak of equation (4)), left peak value (e.g., leftPeak of equation (5)), right peak value (rightPeak of equation (6)), average pixel value and the like.

Frame classification unit 34 determines whether the middle peak (midPeak) is less than a first threshold (THRESH_1) (52). As an example, the first threshold may be equal to 10. As described above, the middle peak (midPeak) is the larger of the difference between the 0.9 quantile and the 0.6 quantile and the difference between the 0.6 quantile and the 0.3 quantile. When the middle peak (midPeak) is less than the first threshold, frame classification unit 34 classifies the frame into a middle peak content class (54).

When the middle peak (midPeak) is greater than or equal to the first threshold, frame classification unit 34 determines whether the average pixel value (AVG) of the histogram is less than or equal to a second threshold (THRESH_2) (56). As one example, the second threshold may be equal to 50. The average pixel value may, for example, be a mean pixel value, a median pixel value or a mode pixel value. When the average pixel value is less than or equal to the second threshold, frame classification unit 34 classifies the frame into a shadow content class (58).

When the average pixel value is greater than the second threshold, frame classification unit 34 determines whether the average pixel value (AVG) of the histogram is greater than or equal to a third threshold (THRESH_{—}3) and a quantile pixel value at a high percentage (e.g., 0.8 quantile) is greater than or equal to a fourth threshold (THRESH_4) (60). Example third and fourth threshold values may be 210 and 60, respectively. When the average pixel value is greater than or equal to the third threshold and the 0.8 quantile pixel value is greater than or equal to the fourth threshold, frame classification unit 34 classifies the frame into a bright content class (62).

When either the average pixel value is less than the third threshold or the 0.8 quantile pixel value is less than the fourth threshold, frame classification unit 34 determines whether the left peak value (leftPeak) is less than or equal to the first threshold THRESH_1 and the right peak value (rightPeak) is less than or equal to the first threshold THRESH_1 (64). As described above, the left peak pixel value is computed as a difference between the pixel value of the 0.1 quantile and the minimum pixel value of the frame and the right peak pixel value is computed as a difference between the maximum pixel value of the frame and the pixel value of the 0.9 quantile. When the left peak pixel value (leftPeak) is less than or equal to the first threshold and the right peak pixel value (rightPeak) is less than or equal to the first threshold, frame classification unit 34 classifies the frame into a two peaks content class (66).

When either the left peak pixel value is greater than the first threshold or the right peak pixel value is greater than the first threshold, frame classification unit 34 determines whether the left peak pixel value (leftPeak) is less than or equal to the first threshold (68). When the left peak pixel value (leftPeak) is less than or equal to the first threshold, frame classification unit 34 classifies the frame into a left peak content class (70).

When the left peak pixel value is greater than the third threshold, frame classification unit 34 determines whether the middle peak (midPeak) is less than a fifth threshold (THRES_5) (72). When the middle peak (midPeak) is less than the fifth threshold, frame classification unit 34 classifies the frame into a normal middle content class (74). When the middle peak (midPeak) is not less than the fifth threshold, frame classification unit 34 classifies the frame into a uniform middle content class (76). In this manner, frame classification unit 34 analyzes the computed variables to classify the frame into one of the content classes.

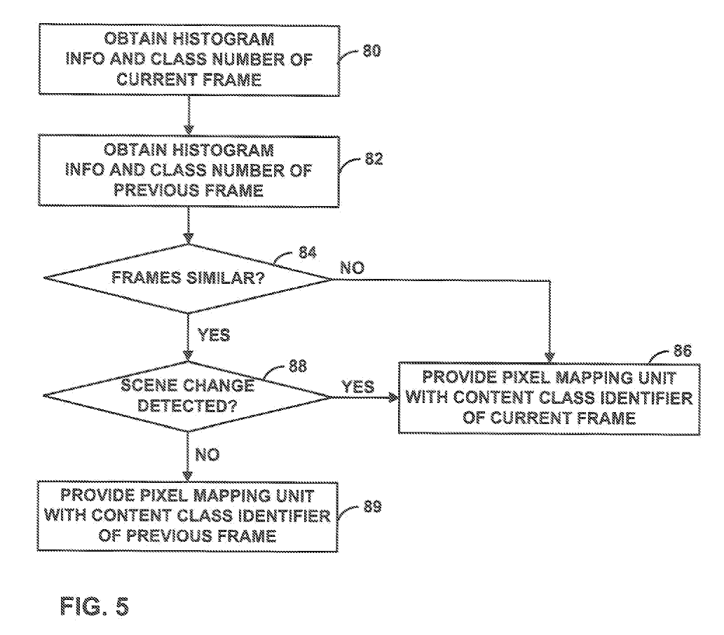

FIG. 5 is a flow diagram illustrating an example operation of a frame classification unit 34 determining the content class to use in performing histogram enhancement for a frame. As described above, frame classification unit 34 may classify two consecutive, e.g., neighboring, frames in a video sequence into two different content classes when the computed parameters of the histogram are close to the content class thresholds. As an example, the histogram of a first frame may have a mean pixel value that is slightly less than the mean threshold value corresponding to a shadow content class and the histogram of a second, consecutive frame may have a mean pixel value that is slightly greater than the mean threshold value corresponding to the shadow content class. Therefore, similar frames may be classified as occupying different content classes. In the example above, frame classification unit 34 may classify the first frame into the shadow content class and classify the second frame into a different context class, e.g., a normal middle content class.

Because the first and second consecutive frames correspond with different content classes, pixel mapping unit 36 adjusts the pixel values of each of the frames differently based on the content class of the frames. Thus, even though the first and second frames are similar, pixel mapping unit 36 adjusts the pixel values of the frames differently. This may result in undesirable artifacts, such as flickering, in the video sequence. To reduce the likelihood of the undesirable artifacts, frame classification unit 34 obtains histogram information, e.g., quantile pixel values, average pixel values and other variables, and the content class of the current frame (80). Frame classification unit 34 also obtains histogram information and the content class of a previous frame (82). Frame classification unit 34 determines whether the current frame and the previous frame are similar (84).

Frame classification unit 34 may compare the histogram information of the current frame and the previous frame to determine whether the frames are similar. Frame classification unit 34 may, for example, compute differences between one or more of the parameters of the histogram information, and compare the computed differences to a threshold to determine whether the frames are similar. When frame classification unit 34 determines that the current frame and the previous frame are not similar, frame classification unit 34 provides pixel mapping unit 36 with the content class identifier of the current frame (86).

When frame classification unit 34 determines that the frames are similar, frame classification unit 34 determines whether a scene change occurs between the frames (88). Frame classification unit 34 may, for example, detect a scene change based on the correlation between current and previous histograms, e.g., based on equation (12) above. Frame classification unit 34 may, however, detect the scene change using any of a number of scene change detection techniques.

When frame classification unit 34 detects a scene change, frame classification unit 34 provides pixel mapping unit 36 with the content class identifier of the current frame (86). When frame classification unit 34 does not detect a scene change, frame classification unit 34 provides pixel mapping unit 36 with the content class identifier of the previous frame (89). In this manner, the content class identifier provided by frame classification unit 34 may indicate that the current frame belongs to a different content class than the content class to which the current frame actually belongs. Pixel mapping unit 36 then performs pixel mapping in the same manner as the previous frame, thus making the two frames more consistent and reducing visual artifacts in the video sequence. For example, the look-up-table to be used for the pixel mapping may be generated as a combination of the look-up table for mapping the content class of the current frame and the look-up table for mapping the pixel values of the content class of the previous frame. The combining of the look-up tables may be performed in accordance with blending coefficient alpha, as shown in the equation (13) above. In the example flow diagram illustrated in FIG. 5, alpha may be equal to zero when the frames are not similar or there is a scene change and equal to one when the frames are similar and there is no scene change. In other instances, alpha may take on a value between zero and one to combine the values of the two LUTs, which provides a smooth transition between histogram enhanced frames.

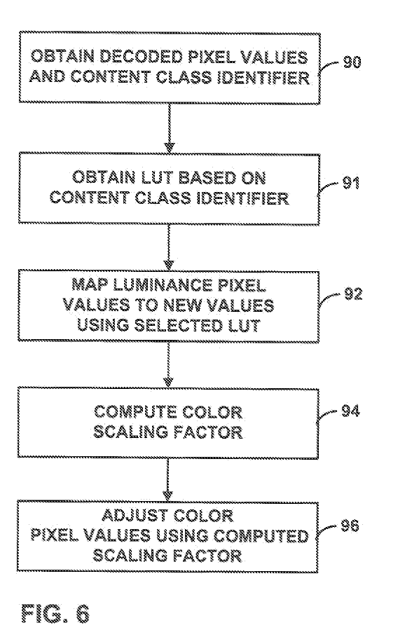

FIG. 6 is a flow diagram illustrating an example operation of a pixel mapping unit 36 adjusting pixel values of a frame in accordance with a mapping function. Pixel mapping unit 36 obtains decoded pixel values of a frame and a content class identifier (90). Pixel mapping unit 36 obtains a LUT 38 to use for mapping the decoded pixel values based on the content class identifier (91). As described above, a plurality of LUTs 38 may be generated during an initialization stage with each of LUTs 38 corresponding with a different content class. Pixel mapping unit 36 may select the one of the plurality of LUTs 38 corresponding to the content class identifier.

Alternatively, pixel mapping unit 36 or other unit may generate the LUT 38 for pixel mapping on the fly. In one aspect, LUTs 38 are generated using a frame-level mapping function that is adaptive based on the content class of the frame. The mapping function may also be capable of adjusting different luminance pixel value ranges differently based on the content class of the frame. For example, the mapping function may be an approximation of a non-linear Gamma curve (e.g., any of equations (7), (9) and (10)) that is capable of adaptively adjusting various luminance pixel value ranges in different manners by adjusting the variables of the function, e.g., a, b, c, ρ and xₘ.

Pixel mapping unit 36 maps the luminance pixel values of the frame to new pixel values using the selected LUT 38 (92). Mapping the luminance pixel values of the frame to new pixel values may enhance the subjective visual quality of the frame. For example, the pixel mapping may adjust the brightness and/or the contrast of the visual scene of the frame to improve the visual quality.

Adjusting the luminance pixel values of the frame may affect the color of the frame. Therefore, pixel mapping unit 36 may compute a color scaling factor (94) and adjust color pixel values of the frame using the computed scaling factor (96). In one aspect, the scaling factor may be derived based on the scaling of the luma component by the pixel mapping function. For example, pixel mapping function may compute the scaling factor (r) used to scale the chroma components as a ratio of the integration of the pixel mapping function ƒ(x) over that of function y=x, expressed in equation (11) above. Pixel mapping unit 36 may include an upper bound, e.g., 1.3, for the scaling factor to reduce the likelihood of over-saturating the color component of the frame.

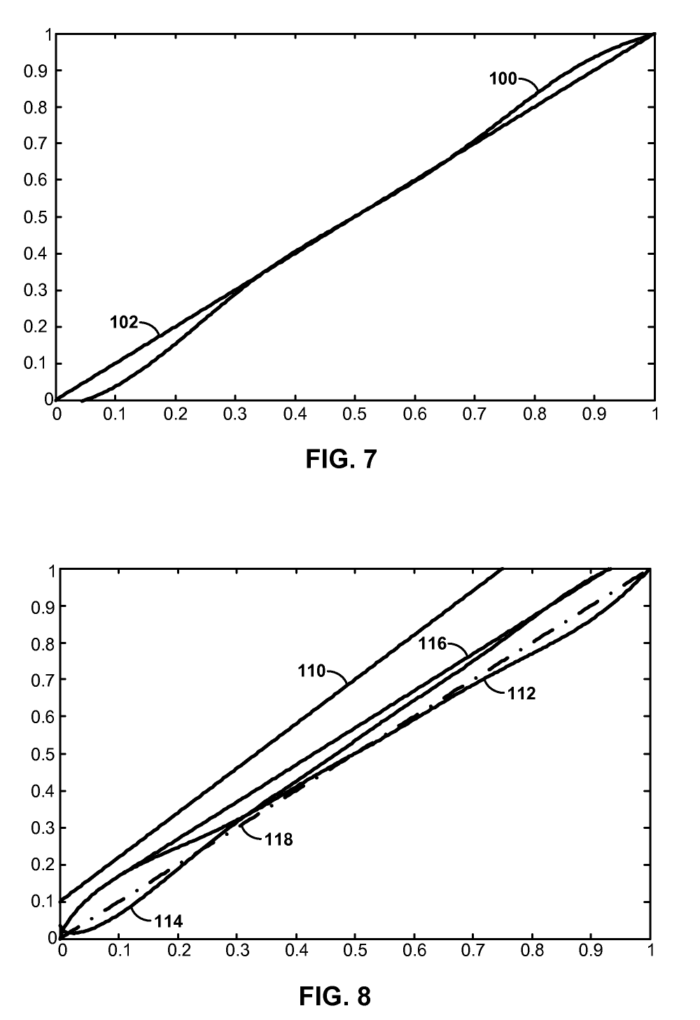

FIG. 7 is a graph showing an example mapping function for contrast enhancement. Line 100 represents mapping function of equation (9) with a=b=c=0.1 and ρ=0.05. Line 102 represents the function y=x. As shown in FIG. 7, the mapping function represented by line 100 decreases pixel values corresponding to dark areas (e.g., the small pixel values) and increases pixel values corresponding to bright areas (e.g., the large pixel values), thus increasing the contrast of the image. The mapping function represented by line 100, however, leaves pixel values in the middle range of pixel values substantially unchanged. Such a mapping function may, for example, be used for mapping pixel values of a frame belonging to the “normal middle” class as it enhances global contrast by making small pixel values even smaller and large pixel values even larger.

FIG. 8 is a graph showing mapping functions for various classes versus a hue saturation intensity control (HSIC) function. The HSIC function (y=a*x+b) is represented by line 110. The mapping functions for reducing contrast, increasing contrast and increasing brightness are represented by lines 112, 114, and 116, respectively. Line 118 represents the function y=x. The various mapping functions represented by lines 112, 114 and 116 may be realized using the mapping function of equation (10) by adjusting variables a, b, c, and ρ. The mapping function represented by line 112 may, for example, be used for mapping pixels in a frame classified in the two peaks content class, the mapping function represented by line 114 may be used for mapping pixel values in a frame classified in the uniform middle content class, and the mapping function represented by line 116 may be used for mapping pixel values in a frame classified in the shadow content class.

As illustrated in FIG. 8, some of the mapping functions, e.g., the function for increasing brightness, i.e., line 116, and increasing contrast, i.e., line 114, may saturate after certain pixel value (e.g., after about a pixel value of 240 for 8-bit representation). To avoid saturation, pixel mapping function may replace the sharp transition with a smooth curve. For example, pixel mapping unit 36 may find a circle with the mapping line and the clamping line as two tangents, and us a part of the circle as the smooth curve to replace the sharp angle. Such a technique may, however, only provide a small increase in quality since frames in these content classes typically have very few pixels with pixel values above the saturation point.

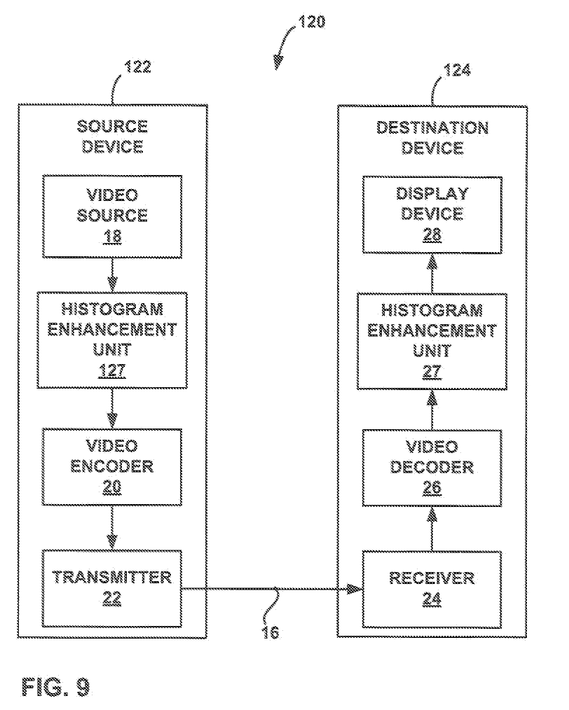

FIG. 9 is another example of a video encoding and decoding system 120 that performs image enhancement techniques as described in this disclosure. System 120 includes a source device 122 that transmits encoded digital image data to a destination device 124 via a communication channel 16. Source device 122 and destination device 124 conform substantially to source device 12 and destination device 14 of FIG. 1, but source device 122 also includes a histogram enhancement unit 127. Histogram enhancement unit 127 may be part of a pre-processing element, such as a video front end to improve efficiency with which the video data is coded. For example, histogram enhancement unit 127 may reduce the dynamic range of certain frames to further increase coding efficiency. After decoding by video decoder 26, histogram enhancement unit 27 can apply another histogram enhancement technique to the reconstructed frames to increase the dynamic range of the frames. As such, histogram enhancement units 27 and 127 may be viewed as being counterparts. Operation of like-numbered components are described in detail with respect to FIG. 1.

FIGS. 10A-10G are graphs illustrating example histograms of frames corresponding to different content classes. In the graphs of FIGS. 10A-10G, the x-axis represents pixel intensity values. In the case of 8-bit color, for example, the pixel intensity values along the x-axis may range from 0 to 255. The y-axis represents the number of pixels in the frame having each particular pixel values, e.g., a magnitude of each of the bins. The pixel histogram represented by the graph in FIG. 10A has a peak located among the lower pixel intensity values, which may represent a shadow content class. The pixel histogram represented by the graph in FIG. 10B has a peak located among the higher pixel intensity values, which may represent a bright content class. The pixel histogram represented by the graph in FIG. 10C has two peaks, one peak located among the lower pixel intensity values and a second peak located among the higher pixel intensity values. Such a histogram may correspond with a two peak content class.

The pixel histogram represented by the graph in FIG. 10D has a sharp peak located among the lower pixel intensity values, which may represent a middle peak content class. The pixel histogram represented by the graph in FIG. 10E illustrates a frame in which there is a peak in the middle, but the pixel intensity values are pretty uniform across the entire range of pixel intensity values. Such a histogram may correspond with a uniform middle content class. The pixel histogram represented by the graph in FIG. 10F has a uniform distribution of pixel intensity values and may correspond with a normal middle content class. The pixel histogram represented by the graph in FIG. 10G has a peak located among the lower pixel intensity values, which may represent a left peak content class. The left peak content class may differ from the shadow content class in that the shadow content class is even darker than the left-peak content class. For example, shadow images have most pixel values in the dark area, e.g., pixel values of [0, 50] while left peak content class images still have many normal brightness area. Thus, images in the shadow content class have less dynamic range and their distribution peak is even more left comparing to that of images in the left peak content class.

Based on the teachings described in this disclosure, it should be apparent that an aspect disclosed herein may be implemented independently of any other aspects and that two or more of these aspects may be combined in various ways. The techniques described in this disclosure may be implemented in hardware, software, firmware, or any combination thereof. Any features described as units or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more DSPs, general purpose microprocessors, ASICs, FPGAs, any combination thereof, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software units or hardware units configured for encoding and decoding, or incorporated in a combined video encoder-decoder (CODEC). Depiction of different features as units is intended to highlight different functional aspects of the devices illustrated and does not necessarily imply that such units must be realized by separate hardware or software components. Rather, functionality associated with one or more units may be integrated within common or separate hardware or software components.

Various embodiments of this disclosure have been described. These and other embodiments are within the scope of the following claims.

1. A method for processing digital image data comprising:
analyzing a distribution of pixel intensity values of a frame of the digital image data to classify the frame into one of a plurality of content classes; and
adjusting the pixel intensity values of the frame based on the classification of the frame.

2. The method of claim 1, wherein analyzing the distribution of pixel intensity values of the frame comprises:
generating a histogram of the pixel intensity values of the frame; and
analyzing a shape of the histogram to classify the frame into one of the plurality of content classes.

3. The method of claim 1, wherein analyzing the shape of the histogram comprises analyzing at least one of a mean pixel intensity value of the histogram, a location of one or more peaks of the histogram, and a width of one or more peaks of the histogram to classify the frame into one of the plurality of content classes.

4. The method of claim 1, wherein the frame comprises a first frame, the method further comprising:
comparing a distribution of pixel intensity values of a second frame of digital image data to the distribution of pixel intensity values of the first frame; and
adjusting the pixel intensity values of the first frame based on a content class of the second frame when the comparison indicates the first and second frame are substantially similar.

5. The method of claim 1, wherein adjusting the pixel intensity values of the frame based on the classification of the frame comprises:
maintaining a plurality of pixel mapping look up tables (LUTs), wherein each of the pixel mapping LUTs corresponds with one of the content classes;
selecting one of the plurality of pixel mapping LUTs based on the content class to which the frame is classified; and
mapping the pixel intensity values of the frame to new pixel intensity values using the selected one of the plurality of LUTs.

6. The method of claim 5, further comprising generating the plurality of LUTs using a pixel mapping function that is adaptive based on the content class to which the frame is classified.

7. The method of claim 1, wherein the pixel intensity values represent luminance (Y) pixel values, the method further comprising adjusting pixel color values representing chrominance values of the frame by multiplying the pixel color values of the frame by a factor.

8. The method of claim 7, wherein the factor used in adjusting the pixel color values of the frame is a ratio between of an integration from 0 to a of a pixel mapping function ƒ(x) used to adjust the pixel intensity values and an integration from 0 to a of function y=x, where a is a chop point.

9. The method of claim 1, wherein each of the plurality of content classes correspond with a level of brightness, a level of contrast or both within the frame.

10. The method of claim 1, wherein the frame of digital image data comprises a frame of a sequence of digital video data.

11. A device for processing digital image data comprising:
a frame classification unit that analyzes a distribution of pixel intensity values of a frame of the digital image data to classify the frame into one of a plurality of content classes; and
pixel mapping unit to adjust the pixel intensity values of the frame based on the classification of the frame.

12. The device of claim 11, wherein the frame classification unit generates a histogram of the pixel intensity values of the frame and analyzes a shape of the histogram to classify the frame into one of the plurality of content classes.

13. The device of claim 11, wherein the frame classification unit analyzes at least one of a mean pixel intensity value of the histogram, a location of one or more peaks of the histogram, and a width of the one or more peaks of the histogram to classify the frame into one of the plurality of content classes.

14. The device of claim 11, wherein the frame comprises a first frame and the frame classification unit compares a distribution of pixel intensity values of a second frame of digital image data to the distribution of pixel intensity values of the first frame and adjusts the pixel intensity values of the first frame based on a content class of the second frame when the comparison indicates the first and second frame are substantially similar.

15. The device of claim 14, wherein the frame classification unit adjusts the pixel intensity values of the first frame based on a combination of a look-up table corresponding with the content class of the first frame and a look-up table corresponding with the content class of the second frame, wherein the look-up tables of the content class of the first frame and the content class of the second frame are combined as a function of an alpha blending function, where alpha is between zero and one.

16. The device of claim 11, further comprising:
a look-up table (LUT) generation unit that maintains a plurality of pixel mapping look-up tables (LUTs), each of the pixel mapping LUTs corresponding with one of the content classes;
wherein the pixel mapping unit selects one of the plurality of pixel mapping LUTs based on the content class to which the frame is classified and maps the pixel intensity values of the frame to new pixel intensity values using the selected one of the plurality of LUTs.

17. The device of claim 16, wherein the LUT generation unit generates the plurality of LUTs using a pixel mapping function that is adaptive based on the content class to which the frame is classified.

18. The device of claim 11, wherein the pixel intensity values represent luminance (Y) pixel values and the pixel mapping unit adjusts pixel color values representing chrominance values of the frame by multiplying the pixel color values of the frame by a factor.

19. The device of claim 18, wherein the factor used in adjusting the pixel color values of the frame is a ratio between of an integration from 0 to a of a pixel mapping function ƒ(x) used to adjust the pixel intensity values and an integration from 0 to a of function y=x, where a is a chop point.

20. The device of claim 11, wherein each of the plurality of content classes correspond with a level of brightness, a level of contrast or both within the frame.

21. The device of claim 11, wherein the frame of digital image data comprises a frame of a sequence of digital video data.

22. The device of claim 11, wherein the device comprises a wireless communication device.

23. The device of claim 11, wherein the device comprises an integrated circuit device.

24. A computer-readable medium for processing digital image data comprising instructions that when executed cause at least one processor to:
analyze a distribution of pixel intensity values of a frame of the digital image data to classify the frame into one of a plurality of content classes; and
adjust the pixel intensity values of the frame based on the classification of the frame.

25. The computer-readable medium of claim 24, wherein the instructions that cause the at least one processor to analyze the distribution of pixel intensity values of the frame comprise instructions to cause the at least one processor to:
generate a histogram of the pixel intensity values of the frame; and
analyze a shape of the histogram to classify the frame into one of the plurality of content classes.

26. The computer-readable medium of claim 24, wherein the instructions that cause the at least one processor to analyze the shape of the histogram comprise instructions that cause the at least one processor to analyze at least one of a mean pixel intensity value of the histogram, a location of one or more peaks of the histogram, and a width of one or more peaks of the histogram to classify the frame into one of the plurality of content classes.

27. The computer-readable medium of claim 24, wherein the frame comprises a first frame, the computer-readable medium further comprising instructions that cause the at least one processor to:
compare a distribution of pixel intensity values of a second frame of digital image data to the distribution of pixel intensity values of the first frame; and
adjust the pixel intensity values of the first frame based on a content class of the second frame when the comparison indicates the first and second frame are substantially similar.

28. The computer-readable medium of claim 24, wherein the instructions that cause the at least one processor to adjust the pixel intensity values of the frame based on the classification of the frame comprise instructions that cause the at least one processor to:
maintain a plurality of pixel mapping look up tables (LUTs), wherein each of the pixel mapping LUTs corresponds with one of the content classes;
select one of the plurality of pixel mapping LUTs based on the content class to which the frame is classified; and
map the pixel intensity values of the frame to new pixel intensity values using the selected one of the plurality of LUTs.

29. The computer-readable medium of claim 28, further comprising instructions that cause the at least one processor to generate the plurality of LUTs using a pixel mapping function that is adaptive based on the content class to which the frame is classified.

30. The computer-readable medium of claim 24, wherein the pixel intensity values represent luminance (Y) pixel values, the computer-readable medium further comprising instructions that cause the at least one processor to adjust pixel color values representing chrominance values of the frame by multiplying the pixel color values of the frame by a factor.

31. The computer-readable medium of claim 30, wherein the factor used in adjusting the pixel color values of the frame is a ratio between of an integration from 0 to a of a pixel mapping function ƒ(x) used to adjust the pixel intensity values and an integration from 0 to a of function y=x, where a is a chop point.

32. The computer-readable medium of claim 24, wherein each of the plurality of content classes correspond with a level of brightness, a level of contrast or both within the frame.

33. The computer-readable medium of claim 23, wherein the frame of digital image data comprises a frame of a sequence of digital video data.

34. A device for processing digital image data comprising:
means for analyzing a distribution of pixel intensity values of a frame of the digital image data to classify the frame into one of a plurality of content classes; and
means for adjusting the pixel intensity values of the frame based on the classification of the frame.

35. The device of claim 34, wherein the analyzing means generate a histogram of the pixel intensity values of the frame and analyze a shape of the histogram to classify the frame into one of the plurality of content classes.

36. The device of claim 34, wherein the analyzing means analyze at least one of a mean pixel intensity value of the histogram, a location of one or more peaks of the histogram, and a width of one or more peaks of the histogram to classify the frame into one of the plurality of content classes.

37. The device of claim 34, wherein the frame comprises a first frame, the device further comprising:
means for comparing a distribution of pixel intensity values of a second frame of digital image data to the distribution of pixel intensity values of the first frame; and
the means for adjusting adjusts the pixel intensity values of the first frame based on a content class of the second frame when the comparison indicates the first and second frame are substantially similar.

38. The device of claim 34, further comprising:
means for maintaining a plurality of pixel mapping look up tables (LUTs), wherein each of the pixel mapping LUTs corresponds with one of the content classes; and
means for selecting one of the plurality of pixel mapping LUTs based on the content class to which the frame is classified;
wherein the adjusting means maps the pixel intensity values of the frame to new pixel intensity values using the selected one of the plurality of LUTs.

39. The device of claim 38, further comprising means for generating the plurality of LUTs using a pixel mapping function that is adaptive based on the content class to which the frame is classified.

40. The device of claim 34, wherein the pixel intensity values represent luminance (Y) pixel values and the adjusting means adjusts pixel color values representing chrominance values of the frame by multiplying the pixel color values of the frame by a factor.

41. The device of claim 40, wherein the factor used in adjusting the pixel color values of the frame is a ratio between of an integration from 0 to a of a pixel mapping function ƒ(x) used to adjust the pixel intensity values and an integration from 0 to a of function y=x, where a is a chop point.

42. The device of claim 34, wherein each of the plurality of content classes correspond with a level of brightness, a level of contrast or both within the frame.

43. The device of claim 34, wherein the frame of digital image data comprises a frame of a sequence of digital video data.
